(19) United States
(12) Patent Application Publication
(10) Pub. No.: US 2018/0229682 A1
(43) Pub. Date: Aug. 16, 2018

(54) Automobile Seat Cover Capable of Releasing Safety Air Bag and Sewing Technology of Seat Cover

(71) Applicant: ZHEJIANG PAN'AN KANGLIDA INDUSTRY CO., LTD., Jinhua (CN)

(72) Inventor: Zhongbao Xu, Jinhua (CN)

(21) Appl. No.: 15/949,079

(22) Filed: Apr. 10, 2018

Related U.S. Application Data
(63) Continuation of application No. PCT/CN2016/094229, filed on Aug. 9, 2016.

(30) Foreign Application Priority Data
Aug. 10, 2015 (CN) 201510485145.X

(51) Int. Cl. B60R 21/215; B60N 2/58; B60R 21/207; D05B 19/12; D05B 69/36; D05B 93/00

(52) U.S. Cl. CPC B60R 21/215; B60N 2/5883; B60R 21/207; D10B 2505/124; D05B 69/36; D05B 93/00; D05D 2205/12; D05B 19/12

(57) ABSTRACT

The present disclosure discloses an automobile seat cover capable of releasing a safety air bag and a sewing technology of a seat cover. An air bag detonation edge is sewn. The air bag detonation edge is defined on the seat cover side cloth and a sewing position between the seat cover backrest cloth and the seat cover rear cloth. A braid with a width of 4 MM is sewn at the air bag detonation edge through an air bag bottom thread and an air bag upper thread. The common computer automobile is reformed, the number of needles and the needle pitch are strictly controlled by biasys computer software, the tension of the air bag bottom thread and the tension of the air bag upper thread are strictly controlled through a tension controller. The upper half part of the seat cover is integrally sewn.

### CROSS REFERENCE TO RELATED APPLICATIONS

The present application is a Continuation Application of PCT Application No. PCT/CN2016/094229 filed on Aug. 9, 2016, which claims the benefit of Chinese Patent Application No. 201510485145.X filed on Aug. 10, 2015. The above is hereby incorporated by reference.

### FIELD

The subject matter herein generally relates to field of safety supplies for passenger vehicle, in particular to a sewing technology of a seat cover and an automobile seat cover capable of releasing a safety air bag.

### BACKGROUND

In order to make the automobile more beautiful, a seat cover is usually used in the automobile seat. The seat cover currently used in the automobile seat is basically sewn by a common sewing machine through sewing directly the seat cover side and the back portion, there is no special technology. When an accident occurs, the seat cover wraps the air bag and makes it impossible to popup, the seat cover cannot provide protection in time. Although an opening with a length of 20 centimeters is defined in the side of the automobile seat cover, the exit position of the air bag cannot fully correspond to the position of the air bag, and some automobiles have big air bags and small air bag openings, thus the air bags are not easy to burst from the air bag openings; when an accident occurs, the seat covers cannot provide protection in time it, and at the same time, these openings are not beautiful enough.

With the improvement of people's awareness of safety, the automobile interior decoration is becoming more and more high-grade, and towards safety. However, the seat covers sold by the current markets are sewn by the common sewing machine, the used seat cover cloth, seat cover side cloth, and polyester line cannot provide guarantee for the popup of the seat side air bag.

Therefore, it is necessary to provide a sewing technology of a seat cover and an automobile seat cover capable of releasing a safety air bag, to avoid serious injury and even death of passengers in the event of a collision when the air bag of a seat side cannot popup for being decorated with the automobile seat cover.

### SUMMARY

The present disclosure aims to overcome the problems existing in the background, and the present disclosure provides an automobile seat cover capable of releasing a safety air bag and a sewing technology of a seat cover. An air bag detonation edge is sewn. The air bag detonation edge is defined on the seat cover side cloth and the sewing position between the seat cover backrest cloth and the seat cover rear cloth. A braid with the width of 4 MM is sewn at the air bag detonation edge through an air bag bottom thread and an air bag upper thread. A common computer automobile is reformed, the number of needles and the needle pitch are strictly controlled by biasys computer software, the tension of the air bag bottom thread and the tension of the air bag upper thread are strictly controlled through a tension controller, to achieve a best effect of air bag bursting edge.

The purpose of the present disclosure is realized through the following technology:

An automobile seat cover capable of releasing a safety air bag comprises a seat cover backrest cloth, a seat cover cloth, a seat cover rear cloth, and a seat cover side cloth; the automobile seat cover capable of releasing a safety air bag further comprises an air bag detonation edge, a braid, an air bag upper thread, and an air bag bottom thread; the seat cover side cloth, the seat cover backrest cloth, and the seat cover rear cloth are sewn to form the air bag detonation edge; the air bag detonation edge is located at a top half of the whole automobile seat cover; the braid with a width of 4 MM is sewn at the air bag detonation edge through the air bag bottom thread and the air bag upper thread.

Preferably, a width of the braid 6 is 4 mm, the braid 6 has strength of 8000 cN.

Preferably, a type of the air bag upper thread 7 is SZKA/040 of Bundy nylon 66 thread, the air bag upper thread 7 has strength of 4500 cN, a type of the air bag bottom thread 8 is 5643/160 of Polyester fluffy thread, and the air bag bottom thread 8 has strength of 600 cN.

Preferably, the automobile seat cover capable of releasing a safety air bag is connected with the seat in the manner of an opening type, an elastic type, a sticky wool type, or a male and female nylon hasp type.

A sewing technology of the automobile seat cover capable of releasing a safety air bag: firstly, the seat cover backrest cloth, the seat cover cloth, and the seat cover side cloth are sewn together to form a whole by a common sewing type; then the whole formed by the seat cover backrest cloth, the seat cover cloth, and the seat cover side cloth defines an opposite face upwards and the seat cover rear cloth defines an opposite face downwards, and the seat cover rear cloth is place below the whole formed by the seat cover backrest cloth, the seat cover cloth, and the seat cover side cloth, with edge-to-edge alignment; biasys computer software is used to control to the sewing machine, and after the number of needles and the needle pitch are set in the biasys computer software, the sewing machine is controlled by the biasys computer software strictly according to the set number of needles and needle pitch; use the air bag upper thread and air bag bottom thread to make the braid directly along a side car to an side edge of a whole sewn by the seat cover backrest cloth, the seat cover cloth, and the seat cover side cloth; when sewing the braid, the air bag upper thread is sewn above the braid and the air bag bottom thread is sewn below the seat cover rear cloth.

Furthermore, a tension controller is used when the biasys computer software is used to control to sew the air bag detonation edge, detect the tension of the air bag upper thread and the air bag bottom thread in the sewing process, if the tension of the air bag upper thread and the air bag bottom thread 8 are greater than or less than 180 cN, the tension controller will raise the alarm and the sewing machine will stop, and it needs to be resewed.

The present disclosure has beneficial effects as follows:

1, the common computer vehicle is reformed, through sewing the air bag detonation edge, and the number of needles and the needle pitch are strictly controlled by the biasys computer software, the tension of the air bag bottom thread and the tension of the air bag upper thread are strictly controlled through a tension controller, thus a best effect of the air bag detonation edge can be achieved. The upper half part of the seat cover is integrally sewn, although the seat air bag is located in different positions, it can ensure the complete release of the seat air bag. When an accident occurs and the air bag popups, the air bag detonation edge will in the first time be burst by the air bag, the popup of the air bag will not be affected and the vehicle safety factor will not be reduced.
2, there are also special requirements for the air bag upper thread, the air bag bottom thread, the seat cover rear cloth, and the seat cover side cloth, to ensure that the air bag can fully popup in the event of an accident and provide protection in time.
3, the automobile seat cover provided by the disclosure has the advantages of simple structure and strong practicability, and effectively improves the usability of the automobile seat cover.

### BRIEF DESCRIPTION OF THE DRAWINGS

Implementations of the present technology will now be described, by way of example only, with reference to the figures.

FIG. 1 is a structure diagram of the present disclosure.

FIG. 2 is a sewing structure diagram of the air bag detonation edge.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

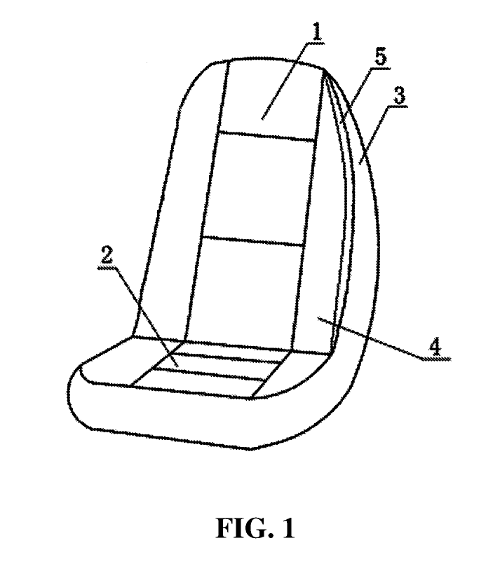

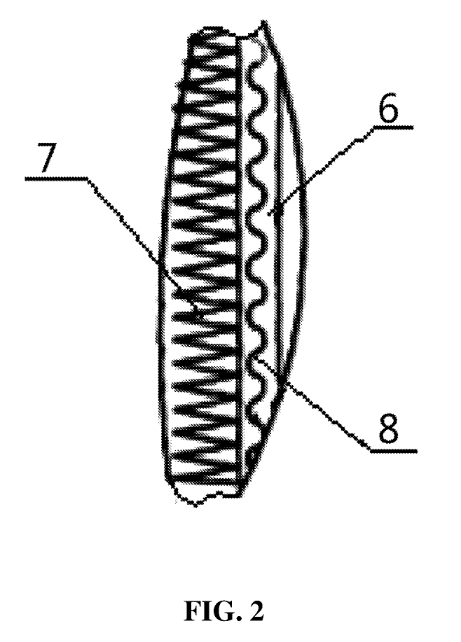

Referring to FIG. 1 and FIG. 2, an automobile seat cover capable of releasing a safety air bag comprises a seat cover backrest cloth 1, a seat cover cloth 2, a seat cover rear cloth 3, and a seat cover side cloth 4. The automobile seat cover capable of releasing a safety air bag further comprises an air bag detonation edge 5, a braid 6, an air bag upper thread 7, and an air bag bottom thread 8. The seat cover side cloth 4, the seat cover backrest cloth 1, and the seat cover rear cloth 3 are sewn to form the air bag detonation edge 5. The air bag detonation edge 5 is located at a top half of the whole automobile seat cover. The braid 6 with a width of 4 MM is sewn at the air bag detonation edge 5 through the air bag bottom thread 8 and the air bag upper thread 7.

A sewing technology of the automobile seat cover capable of releasing a safety air bag: firstly, the seat cover backrest cloth 1, the seat cover cloth 2, and the seat cover side cloth 4 are sewn together to form a whole by a common sewing type; then the whole formed by the seat cover backrest cloth 1, the seat cover cloth 2, and the seat cover side cloth 4 defines an opposite face upwards and the seat cover rear cloth 3 defines an opposite face downwards, and the seat cover rear cloth 3 is place below the whole formed by the seat cover backrest cloth 1, the seat cover cloth 2, and the seat cover side cloth 4, with edge-to-edge alignment; biasys computer software is used to control to the sewing machine, and after the number of needles and the needle pitch are set in the biasys computer software, the sewing machine is controlled by the biasys computer software strictly according to the set number of needles and needle pitch; use the air bag upper thread 7 and air bag bottom thread 8 to make the braid 6 directly along a side car to an side edge of a whole sewn by the seat cover backrest cloth 1, the seat cover cloth 2, and the seat cover side cloth 4; when sewing the braid 6, the air bag upper thread 7 is sewn above the braid 6 and the air bag bottom thread 8 is sewn below the seat cover rear cloth 3. A tension controller is used when the biasys computer software is used to control to sew the air bag detonation edge 5, detect the tension of the air bag upper thread 7 and the air bag bottom thread 8 in the sewing process, if the tension of the air bag upper thread 7 and the air bag bottom thread 8 are greater than or less than 180 cN, the tension controller will raise the alarm and the sewing machine will stop, and it needs to be resewed.

If the tightness of the air bag upper thread 7 and the air bag bottom thread 8 are greater than or less than 180 cN, it will affect the completely releasing of the safety air bag of the automobile to affect the passenger's safety. If the tightness of the air bag upper thread 7 and the air bag bottom thread 8 are equal to 180 cN, it can ensure the production of the safety air bag which can be released completely in 0.03 seconds. The tension controller ensures that the finished sewing thread is not too tight and not too loose, which ensures the effect of the air bag popup.

The braid 6 has strength of 8000 cN. A type of the air bag upper thread 7 is SZKA/040 of Bundy nylon 66 thread, and the air bag upper thread 7 has strength of 4500 cN. A type of the air bag bottom thread 8 is 5643/160 of Polyester fluffy thread, and the air bag bottom thread 8 has strength of 600 cN. The braid 6 with 8000 cN will not be ruptured in the process of the air bag popup, and it is easy to drive the air bag upper thread 7 to rupture the air bag bottom thread 8. The air bag upper thread 7 with 4500 cN touches the bag bottom thread 8 with 600 cN, the bag bottom thread 8 is easy to be ruptured when air bag popups, and it doesn't stop the air bags popup.

When an accident occurs, the sewn automobile seat cover is connected with the automobile in the manner of an opening type, an elastic type, a sticky wool type, or a male and female nylon hasp type. When an accident occurs, the safety air bag receives a signal to inflate and popups, when the safety air bag touches the braid 6, the braid 6 drives the air bag upper thread 7 to rupture the air bag bottom thread 8, thereby enabling the safety air bag to popup. Because the air bag detonation edge 5 is located at a top half of the whole automobile seat cover, even if the seat air bag is located in different positions, it can ensure the complete release of the seat air bag. When an accident occurs and the air bag popups, the air bag detonation edge will in the first time be burst by the air bag, the popup of the air bag will not be affected and the vehicle safety factor will not be reduced.

The common computer automobile is reformed, through sewing the air bag detonation edge, and the number of needles and the needle pitch are strictly controlled by biasys computer software, the tension of the air bag bottom thread and the tension of the air bag upper thread are strictly controlled through a tension controller, thus a best effect of the air bag detonation edge can be achieved. The upper half part of the seat cover is integrally sewn, although the seat air bag is located in different positions, it can ensure the complete release of the seat air bag. When an accident occurs and the air bag popups, the air bag detonation edge will in the first time be burst by the air bag, the popup of the air bag will not be affected and the vehicle safety factor will not be reduced. There are also special requirements for the air bag upper thread, the air bag bottom thread, the seat cover rear cloth, and the seat cover side cloth, to ensure that the air bag can fully popup in the event of an accident and can provide protection in time. The automobile seat cover provided by the present disclosure has the advantages of simple structure and strong practicability, and effectively improves the usability of the automobile seat cover.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An automobile seat cover capable of releasing a safety air bag, comprising:
a seat cover backrest cloth (1);
a seat cover cloth (2);
a seat cover rear cloth (3);
a seat cover side cloth (4);
an air bag detonation edge (5);
a braid (6);
an air bag upper thread (7); and
an air bag bottom thread (8);
wherein the seat cover side cloth (4), the seat cover backrest cloth (1), and the seat cover rear cloth (3) are sewn to form the air bag detonation edge (5);
wherein the air bag detonation edge (5) is located at a top half of the whole automobile seat cover;
wherein the braid (6) with a width of 4 MM is sewn at the air bag detonation edge (5) through the air bag bottom thread (8) and the air bag upper thread (7).

2. The automobile seat cover of claim 1, wherein a width of the braid (6) is 4 mm, the braid (6) has strength of 8000 cN.

3. The automobile seat cover of claim 1, wherein a type of the air bag upper thread (7) is SZKA/040 of Bundy nylon 66 thread, and the air bag upper thread (7)v has strength of 4500 cN, a type of the air bag bottom thread (8) is 5643/160 of Polyester fluffy thread, and the air bag bottom thread (8) has strength of 600 cN.

4. The automobile seat cover of claim 1, wherein the automobile seat cover capable of releasing a safety air bag is connected with the seat in the manner of an opening type, an elastic type, a sticky wool type, or a male and female nylon hasp type.

5. A sewing technology of the automobile seat cover capable of releasing a safety air bag as in claim 1, comprising:
firstly, the seat cover backrest cloth (1), the seat cover cloth (2), and the seat cover side cloth (4) are sewn together to form a whole by a common sewing type; then the whole formed by the seat cover backrest cloth (1), the seat cover cloth (2), and the seat cover side cloth (4) defines an opposite face upwards and the seat cover rear cloth (3) defines an opposite face downwards, and the seat cover rear cloth (3) is place below the whole formed by the seat cover backrest cloth (1), the seat cover cloth (2), and the seat cover side cloth (4), with edge-to-edge alignment; biasys computer software is used to control to the sewing machine, and after the number of needles and the needle pitch are set in the biasys computer software, the sewing machine is controlled by the biasys computer software strictly according to the set number of needles and needle pitch; use the air bag upper thread (7) and air bag bottom thread (8) to make the braid (6) directly along a side car to an side edge of a whole sewn by the seat cover backrest cloth (1), the seat cover cloth (2), and the seat cover side cloth (4); when sewing the braid (6), the air bag upper thread (7) is sewn above the braid (6) and the air bag bottom thread (8) is sewn below the seat cover rear cloth (3).

6. The sewing technology of claim 5, wherein a tension controller is used when the biasys computer software is used to control to sew the air bag detonation edge (5), detect tension of the air bag upper thread (7) and the air bag bottom thread (8) in the sewing process, if the tension of the air bag upper thread (7) and the air bag bottom thread (8) are greater than or less than 180 cN, the tension controller will raise the alarm and the sewing machine will stop, and it needs to be resewed.
